(19) United States
(12) Patent Application Publication
(10) Pub. No.: US 2017/0063176 A1
(43) Pub. Date: Mar. 2, 2017

(54) Single Phase Motor And Electrical Device Using Same

(71) Applicant: Johnson Electric S.A., Murten (CH)

(72) Inventors: Yue LI, Hong Kong (CN); Chui You ZHOU, Shenzhen (CN); Hong Liang Yi, Shenzhen (CN); Yong Gang ZHANG, Shenzhen (CN); Yong WANG, Shenzhen (CN); Wei ZHANG, Shenzhen (CN); Xiao Ning ZHU, Shenzhen (CN); Yong LI, Shenzhen (CN)

(21) Appl. No.: 15/254,230

(22) Filed: Sep. 1, 2016

(30) Foreign Application Priority Data
Sep. 1, 2015 (CN) 2015 1055 2072.1
Mar. 18, 2016 (CN) 2016 1015 7024.7
Jun. 27, 2016 (CN) 2016 1048 5142.0

(51) Int. Cl. H02K 1/14; H02K 3/18; H02K 1/27

(52) U.S. Cl. CPC H02K 1/141; H02K 1/2706; H02K 3/18

(57) ABSTRACT

A single phase motor and an electrical device are provided. The single phase motor includes a stator and a rotor. The stator includes a stator core and a winding wound around the stator core. The stator core includes a yoke and two opposed pole portions. Each pole portion includes short and long pole shoes. The rotor is received in a space defined by the short and long pole shoes of the two pole portions. The short pole shoe of each pole portion and the long pole shoe of the opposite pole portion are located adjacent to each other and define a slot opening therebetween. Each pole portion includes the short pole shoe and long pole shoe, which provides the motor with different startup capabilities along the clockwise and counter-clockwise directions.

### CROSS REFERENCE TO RELATED APPLICATIONS

This non-provisional patent application claims priority under 35 U.S.C. §119(a) from Patent Application No. 201510552072.1 filed in The People's Republic of China on Sep. 1, 2015, Patent Application No. 201610157024.7 filed in The People's Republic of China on Mar. 18, 2016, and Patent Application No. 201610485142.0 filed in The People's Republic of China on Jun. 27, 2016.

### FIELD OF THE INVENTION

The present invention relates to a motor, and in particular to a single phase motor and an electrical device using the single phase motor.

### BACKGROUND OF THE INVENTION

Motors used in conventional ventilation fans are usually Shaded Pole Motors. This type of motor has low efficiency and low power factor, consumes a large amount of copper and iron, and has high cost.

### SUMMARY OF THE INVENTION

Thus, there is a desire for a single phase motor and an electrical device using the single phase motor, which can overcome the above-mentioned shortcomings.

In one aspect, a single phase motor is provided which includes a stator and a rotor rotatable relative to the stator. The stator includes a stator core and a winding wound around the stator core. The stator core includes a yoke and two opposed pole portions connected to the yoke. A short pole shoe and a long pole shoe extend from two sides of each pole portion toward the opposite pole portion. The rotor is received in a space defined by the short pole shoes and long pole shoes of the two pole portions. The short pole shoe of each pole portion and the long pole shoe of the opposite pole portion are located adjacent to each other and define a slot opening therebetween.

Preferably, the two pole portions define two slot openings therebetween, and a line connecting centers of the two slot openings is inclined relative to an axis of symmetry of the stator core.

Preferably, the line connecting the centers of the two slot openings is inclined relative to the axis of symmetry of the stator core by an angle of 0 to 30 degrees.

Preferably, end faces of the short pole shoe and long pole shoe of each pole portion facing the corresponding slot openings are parallel to the line connecting the centers of the two slot openings.

Preferably, the long pole shoe of each pole portion has a beveled portion such that a radial thickness of the long pole shoe progressively decreases in a direction toward the corresponding slot opening.

Preferably, each pole portion defines a positioning groove facing the rotor, and the positioning groove is offset from a center of the pole portion and located in an inner surface of the short pole shoe.

Preferably, a bottom of the positioning groove is arc-shaped.

Preferably, an outer circumferential surface of the rotor is located on a same circumference, an air gap with an even thickness is defined between the rotor and inner surfaces of the short pole shoe and long pole shoe of each pole portion.

Preferably, the rotor comprises a rotor main body, the rotor main body comprises a magnetic member mounting bracket and a permanent magnet member, the permanent magnet member is mounted to an outer side of the magnetic member mounting bracket, and an outer circumferential surface of the permanent magnet member is located on a same circumference.

Preferably, an outer profile of the stator core overall is rectangular in shape.

Preferably, an outer diameter of the rotor is 50%-70% of a width of the stator core.

Preferably, the stator core comprises a first core part and a second core part, the two opposed pole portions are respectively integrally formed with a first end of the first core part and a first end of the second core part, and a second end of the first core part and a second end of the second core part are coupled to each other.

Preferably, the second end of the first core part and the second end of the second core part are coupled to each other by a magnetic-conductive connecting piece.

Preferably, two dovetail grooves are defined in the second end of the first core part and the second end of the second core part respectively, two opposite ends of the magnetic-conductive connecting piece are respectively formed with dovetail tenons, and the dovetail tenons are engaged in the dovetail grooves.

Preferably, the rotor comprises a rotary shaft, a rotor main body attached around the rotary shaft, and a buffering device received within the rotor main body. The rotor main body and the rotary shaft have a sliding fit with each other. The buffering device has two ends connected to the rotary shaft and the rotor main body, respectively, for time delay synchronizing rotation speeds between the rotor main body and the rotary shaft.

In another aspect, the present invention provides an electrical device comprising the single phase motor described in any of the above embodiments.

Preferably, the electrical device is a ventilation fan, the ventilation fan comprises an impeller, the impeller is mounted to a rotary shaft of the rotor of the single phase motor.

Preferably, the electrical device is a drain pump or a circulation pump.

In comparison with the prior art, each pole portion of the single phase motor of the present invention includes the short pole shoe and long pole shoe at two sides of the pole portion, thereby providing different startup capabilities along the clockwise direction and counter-clockwise direction. The short pole shoe of each pole portion and the long pole shoe of the other pole portion are located adjacent to each other and define the slot opening therebetween, which facilitates reducing the inductance and strengthening the unidirectional startup capability of the motor.

### BRIEF DESCRIPTION OF THE DRAWINGS

FIG. 1 illustrates a ventilation fan according to one embodiment of the present invention.

FIG. 2 illustrates a motor assembly of the ventilation fan of FIG. 1.

FIG. 3 illustrates an insulating bracket of a single phase motor of FIG. 2.

FIG. 4 is a plane view of a stator core of the single phase motor of FIG. 2.

FIG. 5 is a plane view of the stator core and a rotor of the single phase motor of FIG. 2.

FIG. 6 is an exploded view of the stator core of FIG. 4.

FIG. 7 illustrates a rotor of the single phase motor of FIG. 2.

FIG. 8 and FIG. 9 are exploded views of the rotor of FIG. 7.

FIG. 10 illustrates an electrical device using the ventilation fan of FIG. 1.

FIG. 11 illustrates a circulation pump using the single phase motor of FIG. 2.

FIG. 12 illustrates a drain pump using the single phase motor of FIG. 2.

### DETAILED DESCRIPTION OF THE PREFERRED EMBODIMENTS

Below, embodiments of the present invention are described in further detail with reference to the drawings.

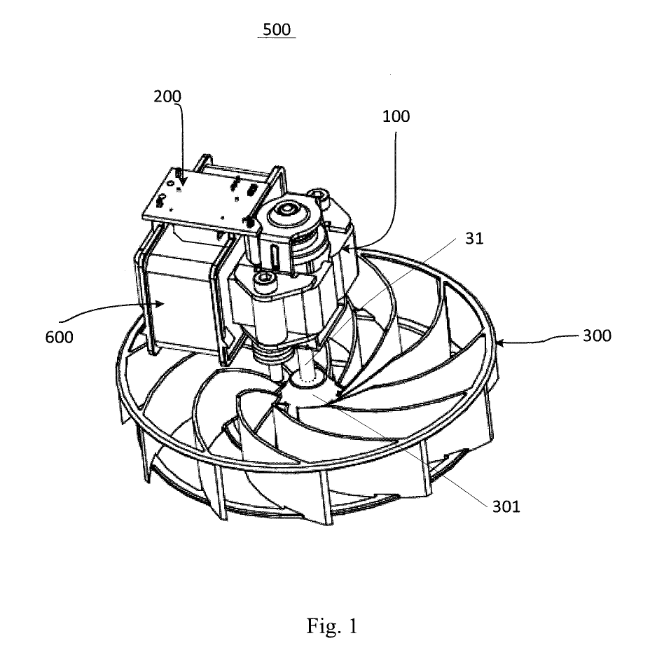

Referring to FIG. 1, a ventilation fan 500 of the present invention includes an impeller 300 and a motor assembly 600. The motor assembly 600 includes a single phase motor 100 and a driving circuit. The impeller 300 includes a mounting portion 301 mounted to one end of a rotary shaft 31 of the single phase motor 100, so that the impeller 300 is driven to rotate by the rotary shaft 31. In this embodiment, the single phase motor 100 is a single phase synchronous alternating current motor. In comparison with the traditional shaded pole motor, the single phase motor of the present invention has a compact structure and is convenient to repair and replace. The driving circuit includes a PCB board 200 mounted to the single phase motor 100. In this embodiment, the impeller 300 is a centrifugal impeller and has an outer diameter significantly greater than the size of the single phase motor 100.

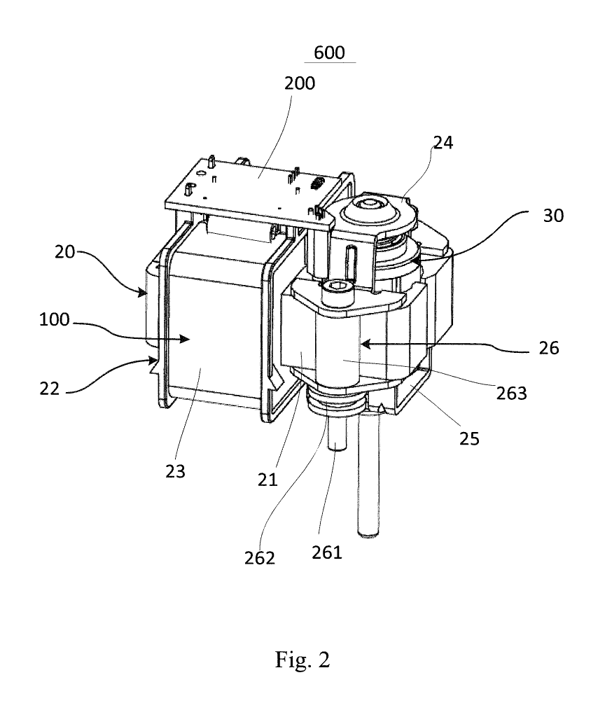

Referring to FIG. 2, the single phase motor 100 of the motor assembly 600 includes a stator 20 and a rotor 30 rotatable relative to the stator 20. The stator 20 includes a stator core 21, an insulating bracket 22 mounted to the stator core 21, and a winding 23 wound around the insulating bracket 22. In this embodiment, the PCB board 200 is mounted to the insulating bracket 22 adjacent the winding 23. Preferably, the PCB board 200 is mounted to one side of the insulating bracket 22 facing away from the impeller 300. This can make the structure of the single phase motor 100 more compact and reduce the size of the single phase motor 100. In addition, during operation of the impeller 300, a low pressure area is formed at a central region of the impeller 300, which causes external air to flow to this low pressure area, and the single phase motor 100, the PCB board 200 and the winding 23 are located in this low pressure area. Therefore, a flow passage exists between the PCB board 200 and the impeller 300, which allows air to flow therethrough. This airflow may flow over and directly cool the PCB board 200, thus prolonging the lifespan of the PCB board 200. Because the outer diameter of the impeller 300 is significantly greater than the size of the single phase motor 100, the PCB board 200 can be sufficiently cooled. In an alternative embodiment, the impeller 300 may also be an axial impeller.

The stator 20 further includes a first support bracket 24 and a second support bracket 25 respectively mounted to two axial sides of the stator core 21. The stator core 21 is made from a magnetic-conductive material. The first support bracket 24 and the second support bracket 25 are configured to support the rotary shaft 31 of the rotor 30. The first support bracket 24 and the second support bracket 25 are interconnected through an axial connecting mechanism 26 so as to sandwich the stator core 21 between the first and second support brackets 24, 25. In this embodiment, each of the first support bracket 24 and the second support bracket 25 is an integrally formed part, which is convenient to fabricate. Bearing seats are disposed in the first support bracket 24 and the second support bracket 25, for mounting of bearings 24a, 25a (FIG. 7), respectively. The two bearings 24a, 25a support the rotary shaft 31 such that the rotary shaft 31 is capable of rotating relative to the stator 20.

The connecting mechanism 26 includes a screw 261, an associated screw nut 262, and a positioning sleeve 263. The first support bracket 24 and the second support bracket 25 define through holes for allowing the screw 261 to pass therethrough. The positioning sleeve 263 is attached around the screw 261 and disposed between the first support bracket 24 and the second support bracket 25 for axially positioning and supporting the first support bracket 24 and the second support bracket 25 and improving the appearance.

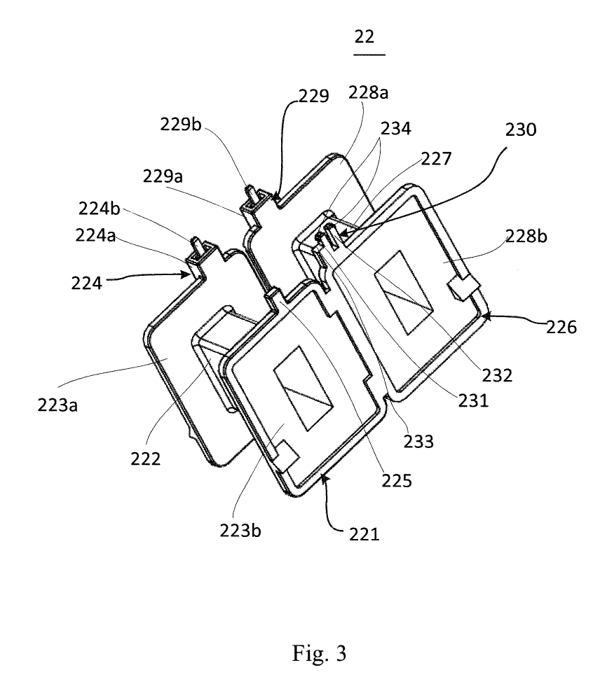

Referring to FIG. 3, in this embodiment, the insulating bracket 22 includes a first insulating bracket 221 and a second insulating bracket 226 that are integrally formed. The first insulating bracket 221 and the second insulating bracket 226 include integrally formed main portions 222, 227, respectively. Side plates 223a, 223b are formed at two ends of the main portion 222, and side plates 228a, 228b are fanned at two ends of the main portion 227. The main portions 222, 227 are attached around the stator core 21. The winding 23 includes a first winding and a second winding that are wound around the main portions 222, 227, respectively.

Top ends of one side plate 223a and one side plate 228a of the first insulating bracket 221 and the second insulating bracket 226 form protruding first mounting portions 224, 229, respectively. Top ends of the other side plate 223b and the other side plate 228b of the first insulating bracket 221 and the second insulating bracket 226 form protruding second mounting portions 225, 230, respectively. The first mounting portions 224, 229 and the second mounting portions 225, 230 are configured for mounting of the PCB board 200.

The first mounting portion 224 of the first insulating bracket 221 and the first mounting portion 229 of the second insulating bracket 226 include support portions 224a, 229a and connecting members 224b, 229b disposed at top ends of the support portions 224a, 229a, respectively. The support portions 224a, 229a are flush with the side plates 223a, 228a. The connecting members 224b, 229b pass through first through holes of the PCB board 200 to position and fixedly connect the PCB board 200. The top ends of the support portions 224a, 229a abut against an underside of the PCB board 200 to support the PCB board 200.

The top end of the second mounting portion 225 of the first insulating bracket 221 abuts against the underside of the PCB board 200 to support the PCB board 200. The second mounting portion 230 of the second insulating bracket 226 includes a support portion 233 and two parallel connecting members 231, 232 disposed on the support portion 233. The support member 233 abuts against the underside of the PCB board 200 to support the PCT board 200. Ends of the two connecting members 231, 232 are formed with two barbs 234, respectively. The two connecting members 231, 232 pass through second through holes of the PCB board 200, with the barbs 234 engaged with a top side of the PCB board 200 to hold the PCB board 200 and prevent the PCB board 200 from becoming loosened.

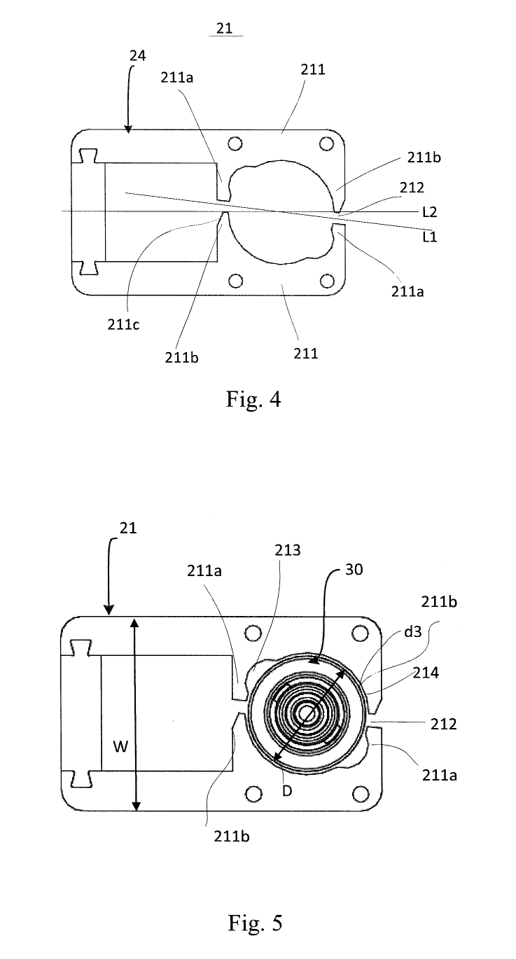

Referring to FIG. 4, the stator core 21 includes a generally U-shaped yoke 24, and two pole portions 211 extending toward each other from two opposing side portions of the yoke 24. The first insulating bracket 221 and the second insulating bracket 226 are mounted to the two opposing side portions, respectively. Each pole portion 211 includes a short pole shoe 211a and a long pole shoe 211b extending from two sides of the pole portion 211. Because of asymmetry of the pole portion 211, the single phase motor 100 has different startup capability in opposite directions, i.e. the startup capability in one startup direction is greater than the startup capability in the other startup direction. Between the two pole portions 211, the short pole shoe 211a of each pole portion 211 and the long pole shoe 211b of the other pole portion 211 are located adjacent to each other and define a slot opening 212 therebetween. As such, a center of the slot opening 212 is offset from a center line or an axis of symmetry L2 of the stator core 21 along a length direction of the stator core 21. A line L1 connecting the centers of the two slot openings 212 is inclined relative to the axis of symmetry L2 by an angle of 0 to 30 degrees. This design facilitates increasing the magnetic reluctance between the two pole portions 211, which reduces the inductance, enhances the unidirectional startup capability and working efficiency, and increases the power factor. In this embodiment, end faces of the short pole shoe 211a and long pole shoe 211b of each pole portion 211 that face the respective slot openings 212 are parallel to the line Ll. The long pole shoe 211b of each pole portion 211 has a beveled portion 211c such that a radial thickness of the long pole shoe 211b progressively decreases in a direction toward the respective slot opening 212, thereby reducing the inductance and enhancing the unidirectional startup capability of the single phase motor 100.

Referring to FIG. 5, the rotor 30 is received in a space defined by the short pole shoes 211a and long pole shoes 211b of the two pole portions 211. Each pole portion 211 defines a positioning groove 213 facing the rotor 30. The positioning groove 213 is offset from a center of the corresponding pole portion 211 and located away from the corresponding long pole shoe 211b. This configuration makes the length difference between the long pole shoe 211b and short pole shoe 211a of each pole portion 211 even greater, thereby better controlling the stop position of the rotor 30 to make the stop position of the rotor 30 offset from a dead point and make it easier for the rotor 30 to start in one direction than in the other direction. Preferably, a bottom of the positioning groove 213 is arc-shaped. It should be understood that the bottom of the positioning groove 213 can also be V-shaped.

An outer circumferential surface of the rotor 30 is located on a same circumference in an axial plan view of stator 100. Inner surfaces of the short pole shoe 211a and long pole shoe 211b of each pole portion 211 are inwardly-recessed arc pole faces. The pole faces of the short pole shoe 211a and long pole shoe 211b are located on a same circumference in the axial plan view of the stator 100. The pole faces of the short pole shoe 211a and the long pole shoe 211b are concentric with the outer circumferential surface of the rotor 30, i.e. the pole faces of the short pole shoe 211a and long pole shoe 211b and the outer circumferential surface of the rotor 30 are all centered at the center of the rotor 30. Therefore, an air gap 214 with an even thickness is defined between the short pole shoe 211a, the long pole shoe 211b and the rotor 30, which can improve the smoothness and stability and hence reliability of the startup of the single phase motor 100.

In this embodiment, the slot opening 212 has a width (i.e. a distance between the short pole shoe 211a and long pole shoe 211b at opposite sides of the slot opening 212) greater than a thickness d3 of the air gap 214.

In this embodiment, the outer profile of the stator core 21 overall is rectangular in shape. A width of the stator core 21 is indicated by W, an outer diameter of the rotor 30 is indicated by D, and the outer diameter D of the rotor 30 is 50%-70% of the width W of the stator core 21. This configuration reduces the size and the cost of the single phase motor 100, which makes the single phase motor 100 more cost-effective.

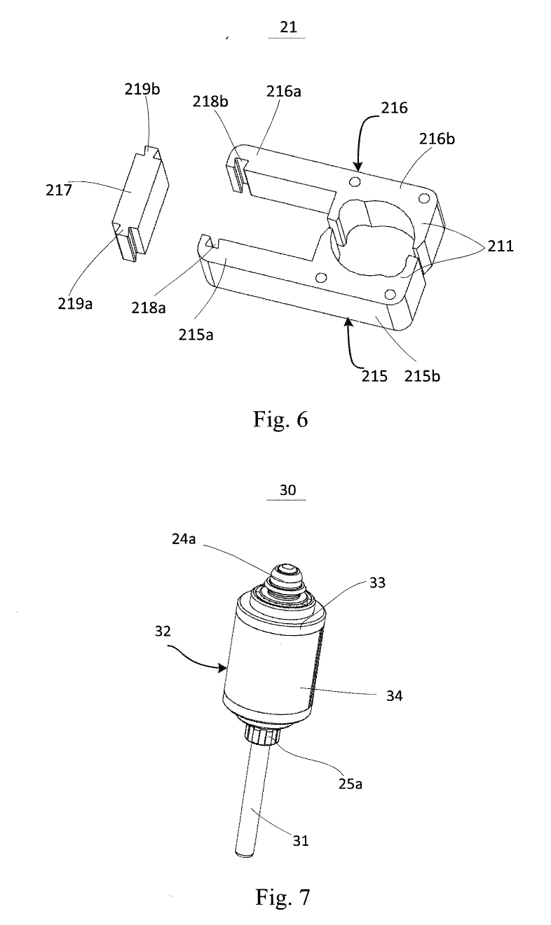

Referring to FIG. 6, the stator core 21 is frame shaped with an opening. The stator core 21 includes a first core part 215 and a second core part 216 that are connected by a magnetic-conductive connecting piece 217. The main portion 222 of the first insulating bracket 221 and the main portion 227 of the second insulating bracket 226 are attached around the first core part 215 and the second core part 216, respectively.

A first end 215a of the first core part 215 and a first end 216a of the second core part 216 are respectively formed with dovetail grooves 218a, 218b. Two opposite ends of the magnetic-conductive connecting piece 217 are respectively formed with dovetail tenons 219a, 219b. The dovetail tenons 219a, 219b are engaged in the dovetail grooves 218a, 218b, such that the first core part 215, the second core part 216 and the magnetic-conductive connecting piece 217 are connected and locked. A second end 215b of the first core part 215 and a second end 216b of the second core part 216 form the two opposed pole portions 211, respectively.

In this embodiment, both the first core part 215 and the second core part 216 are F-shaped.

In an alternative embodiment, both the first core part 215 and the second core part 216 are E-shaped.

It should be understood that the first core part 215 and the second core part 216 may also be directly connected by engagement between a dovetail groove/dovetail tenon at the first end 215a of the first core part 215 and a dovetail tenon/dovetail groove at the first end 216a of the second core part 216, without using the magnetic-conductive connecting piece 217.

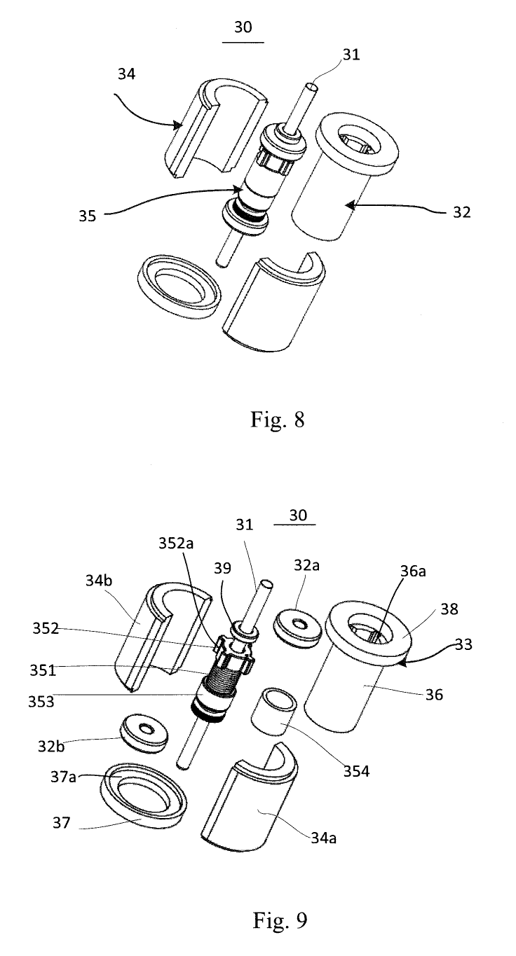

Referring to FIGS. 7 to 9, the rotor 30 includes a rotary shaft 31, a rotor main body 32 and a buffering device 35. The rotor main body 32 is attached around the rotary shaft 31. The rotary shaft 31 is supported by the two bearings 24a, 25a. The two bearings 24a, 25a are located outside two ends of the rotor main body 32. The rotor 30 is rotatable relative to the stator 20. The rotor main body 32 includes a magnetic member mounting bracket 33 and a permanent magnet member 34. The magnetic member mounting bracket 33 is an injection-molded part. The permanent magnet member 34 is mounted to an outer side of the magnetic member mounting bracket 33, and an outer circumferential surface of the permanent magnet member 34 is located on a same circumference in an axial plan view of the rotor.

In particular, the rotor main body 32 and the rotary shaft 31 have a sliding fit with each other to allow for a rotation speed difference therebetween. The buffering device 35 is disposed within the rotor main body 32 and attached around the rotary shaft 31. The buffering device 35 has one end connected to the rotor main body 32, and the other end of the buffering device 35 is connected to the rotary shaft 31, for synchronizing with time delay the rotation speeds between the rotor main body 32 and the rotary shaft 31, which can effectively reduce or eliminate the occurrence of the startup failure or stall of the motor 100. The buffering device 35 is disposed in the interior of the rotor main body 32 and hence one end of the rotary shaft 31 of the single phase motor 100 is directly connected to a load, which results in a more compact structure of the motor 100 and facilitates repairmen and replacement of the motor 100.

The magnet member mounting bracket 33 of the rotor main body 32 includes a hollow cylindrical portion 36, a lower cover 37 fixedly attached around a lower end of the hollow cylindrical portion 36, and a sleeve ring 38 formed on an upper end of the hollow cylindrical portion 36. The hollow cylindrical portion 36 and the sleeve ring 38 is injection-molded integral part which can be convenient to fabricate. The permanent magnet member 34 is formed by two arcuate permanent magnet members 34a, 34b attached to the outer side of the hollow cylindrical portion 36. Two bearings 32a, 32b are respectively mounted within two ends of the hollow cylindrical portion 36. The two bearings 32a, 32b have a sliding fit with the rotary shaft 31, which allows the rotor main body 32 to freely rotate relative to the rotary shaft 31. The buffering device 35 is disposed between the two bearings 32a, 32b, which can prevent axial displacement of the rotor main body 32.

The sleeve ring 38 and the lower cover 37 have opposed grooves, and the groove 37a of the lower cover 37 is opposed to the groove (which is invisible in the figures) of the sleeve ring 38. Two ends of the permanent magnet member 34 are engaged in the grooves to axially position the permanent magnet member 34.

The buffering device 35 includes an elastic member 351, and a first connecting base 352 and a second connecting base 353 connected to two ends of the elastic member 351. The first connecting base 352 is movably attached around the rotary shaft 31, and the second connecting base 353 is fixedly attached around the rotary shaft 31. The hollow cylindrical portion 36 surrounds an outer circumferential side of the buffering device 35. The first connecting base 352 is connected to the hollow cylindrical portion 36. Specifically, in this embodiment, the first connecting base 352 includes four circumferentially arranged protruding blocks 352a, and an inner wall surface of the hollow cylindrical portion 36 includes grooves 36a engaged with the protruding blocks 352a so as to connect the first connecting base 352 to the hollow cylindrical portion 36.

The rotor 30 further includes a limiting ring 39 fixedly attached to the rotary shaft 31 and disposed outside one end of the rotor main body 32 away from the second connecting base 353. As such, the two ends of the rotor main body 32 are respectively position-limited by the second connecting base 353 and the limiting ring 39. During operation of the single phase motor 100, the limiting ring 39 axially limits the rotor main body 32, which prevents axial movement of the rotor main body 32.

In this embodiment, the buffering device 35 further includes an elastic sleeve 354. The sleeve 354 is disposed at an inner side of the hollow cylindrical portion 36 and surrounds an outer circumferential side of the elastic member 351. Two ends of the sleeve 354 are fixedly connected to the first connecting base 352 and the second connecting base 353, respectively. Preferably, the material of the sleeve 354 is a soft material such as rubber or foamed plastic, which on one hand achieves shock-absorbing and noise reduction results and, on the other hand, prevents the elastic member 351 from directly striking on the hollow cylindrical portion 36 when an outer diameter of the elastic member 351 increases.

In this embodiment, the elastic member 351 is a helical spring movably attached around the rotary shaft 31. When the motor 10 begins starting, the rotor main body 32 rotates under the driving of the electromagnetic force of the stator 20. One end of the rotary shaft 31 is directly connected to a load so that the rotary shaft 31 has a large inertia, and the rotary shaft 31 has a sliding fit with the rotor main body 32. Therefore, at this time, the rotation speed of the rotor main body 32 is greater than the rotation speed of the rotary shaft 31, i.e. a rotation speed difference exists between the rotor main body 32 and the rotary shaft 31. The helical spring is pulled by the rotation of the rotor main body 32, such that the end of the helical spring that is connected to first connecting base 352 is tightened with its inner diameter gradually decreasing. As a result, the end of the helical spring that is connected to the second connecting base 353 is also gradually tightened, and the rotation speed of the rotary shaft 31 is eventually synchronous with the rotation speed of the rotator main body 32, which effectively reduces the inertia of the single phase motor 100 brought by the load at the startup. When the motor 100 stops from an operation state, because of the large rotational inertia of the load, the rotation speed of the rotary shaft 31 is greater than the rotation speed of the rotor main body 32, i.e. a rotation speed difference exists between the rotor main body 32 and the rotary shaft 31, such that the end of the helical spring that is connected to the second connecting base 353 is gradually loosened with its inner diameter gradually increasing. As a result, the end of the helical spring that is connected to the first connecting base 352 is also gradually loosened, and the rotation speed of the rotator main body 32 is eventually synchronous with the rotation speed of the rotary shaft 31, such that the load can be effectively reduced. During this course, the sleeve 354 surrounds the helical spring, which prevents the helical spring from being damaged due to over-increasing of its inner diameter.

The single phase motor 100 of the present invention has a compact structure and has the advantages of strong unidirectional startup capability, high working efficiency, high power factor and low cost. Therefore, the ventilation fan 500 using the single phase motor 100 of the present invention has high working efficiency, low cost and long lifespan.

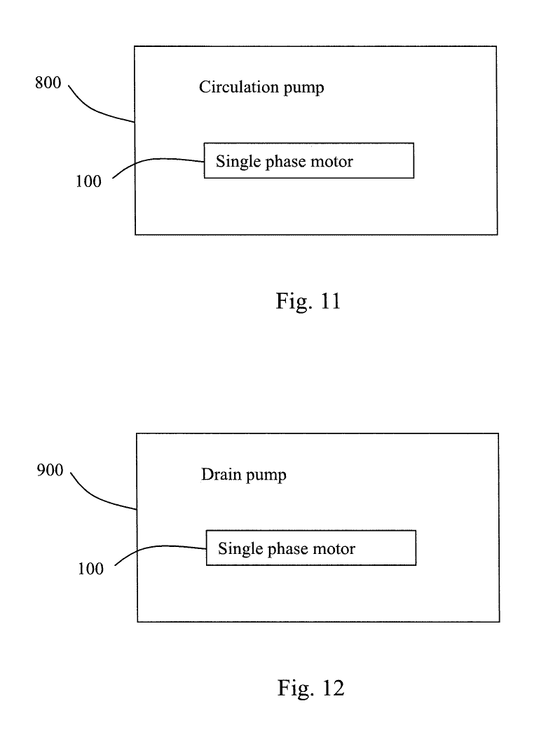

It should be understood that the single phase motor 100 of the present invention can also be used in electrical devices having a unidirectional startup requirement of the single phase motor 100, such as a warm-air machine, an air conditioner drain pump 900, or a circulation pump 800 (see FIGS. 11-12).

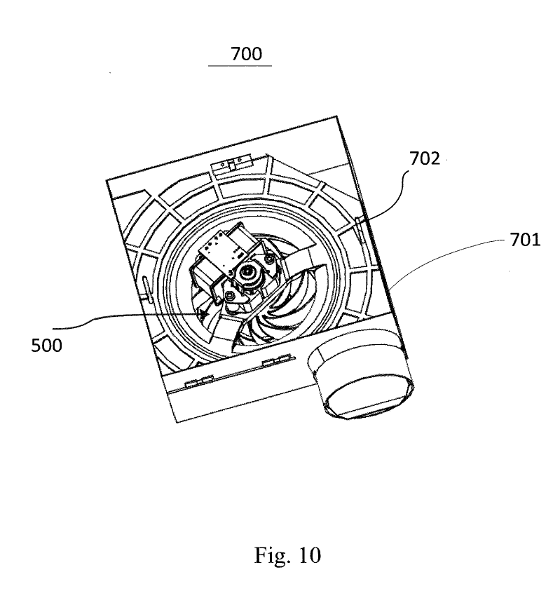

FIG. 10 illustrates an electrical device 700 using the ventilation fan 500 of the present invention. The electrical device 700 includes an outer housing 701 and a mounting bracket 702 disposed in an interior of the outer housing 701. The ventilation fan 500 is mounted to the mounting bracket 702. The electrical device 700 using the ventilation fan 500 of the present invention has high work efficiency, long lifetime and low cost. The electrical device 700 can be, for example, an air ventilation device, a ventilation and cooling device, a range hood, or the like.

Although the invention is described with reference to one or more preferred embodiments, it should be appreciated by those skilled in the art that various modifications are possible. Therefore, the scope of the invention is to be determined by reference to the claims that follow.

1. A single phase motor comprising:
a stator comprising a stator core and a winding wound around the stator core, the stator core comprising a yoke and two opposed pole portions connected to the yoke, a short pole shoe and a long pole shoe extending from two sides of each of the pole portions toward the opposite pole portion, the short pole shoe of each pole portion and the long pole shoe of the opposite pole portion being located adjacent to each other and defining a slot opening therebetween; and
a rotor rotatable relative to the stator, the rotor being received in a space defined by the short pole shoes and long pole shoes of the two pole portions.

2. The single phase motor of claim 1, wherein the two pole portions define two slot openings therebetween, and a line connecting centers of the two slot openings is inclined relative to an axis of symmetry of the stator core.

3. The single phase motor of claim 2, wherein the line connecting the centers of the two slot openings is inclined relative to the axis of symmetry of the stator core by an angle of 0 to 30 degrees.

4. The single phase motor of claim 2, wherein end faces of the short pole shoe and long pole shoe of each pole portion facing the corresponding slot openings are parallel to the line connecting the centers of the two slot openings.

5. The single phase motor of claim 1, wherein the long pole shoe of each pole portion has a beveled portion such that a radial thickness of the long pole shoe progressively decreases in a direction toward the corresponding slot opening.

6. The single phase motor of claim 1, wherein each pole portion defines a positioning groove facing the rotor, and the positioning groove is offset from a center of the pole portion and located in an inner surface of the short pole shoe.

7. The single phase motor of claim 6, wherein a bottom of the positioning groove is arc-shaped.

8. The single phase motor of claim 1, wherein an outer circumferential surface of the rotor is located on a same circumference, an air gap with an even thickness is defined between the rotor and inner surfaces of the short pole shoe and long pole shoe of each pole portion.

9. The single phase motor of claim 1, wherein the rotor comprises a rotor main body, the rotor main body comprises a magnetic member mounting bracket and a permanent magnet member, the permanent magnet member is mounted to an outer side of the magnetic member mounting bracket, and an outer circumferential surface of the permanent magnet member is located on a same circumference.

10. The single phase motor of claim 1, wherein an outer profile of the stator core overall is rectangular in shape.

11. The single phase motor of claim 10, wherein an outer diameter of the rotor is 50%-70% of a width of the stator core.

12. The single phase motor of claim 1, wherein the stator core comprises a first core part and a second core part, the two opposed pole portions are respectively integrally formed with a first end of the first core part and a first end of the second core part, and a second end of the first core part and a second end of the second core part are coupled to each other.

13. The single phase motor of claim 12, wherein the second end of the first core part and the second end of the second core part are coupled to each other by a magnetic-conductive connecting piece.

14. The single phase motor of claim 13, wherein two dovetail grooves are defined in the second end of the first core part and the second end of the second core part respectively, two opposite ends of the magnetic-conductive connecting piece are respectively formed with dovetail tenons, and the dovetail tenons are engaged in the dovetail grooves.

15. The single phase motor of claim 1, wherein the rotor comprises a rotary shaft, a rotor main body attached around the rotary shaft, and a buffering device received within the rotor main body, the rotor main body and the rotary shaft have a sliding fit with each other, the buffering device has two ends connected to the rotary shaft and the rotor main body, respectively, for time delay synchronizing rotation speeds between the rotor main body and the rotary shaft.

16. An electrical device comprising a single phase motor, the single phase motor comprising:
a stator comprising a stator core and a winding wound around the stator core, the stator core comprising a yoke and two opposed pole portions connected to the yoke, a short pole shoe and a long pole shoe extending from two sides of each of the pole portion toward the opposite pole portion, the short pole shoe of each pole portion and the long pole shoe of the opposite pole portion being located adjacent to each other and defining a slot opening therebetween; and
a rotor rotatable relative to the stator, the rotor being received in a space defined by the short pole shoes and long pole shoes of the two pole portions.

17. The electrical device of claim 16, wherein the electrical device is a ventilation fan, the ventilation fan comprises an impeller, the impeller is mounted to a rotary shaft of the rotor of the single phase motor.

18. The electrical device of claim 16, wherein the electrical device is a drain pump or a circulation pump.
